(19) United States
(12) Patent Application Publication
(10) Pub. No.: US 2012/0173398 A1
(43) Pub. Date: Jul. 5, 2012

(54) Apparatuses, Systems, and Methods for Health and Wealth Planning

(76) Inventors: Cara Sjodin, St. Paul, MN (US); Scott Guillemette, Chaska, MN (US)

(21) Appl. No.: 13/312,354

(22) Filed: Dec. 6, 2011

Related U.S. Application Data
(60) Provisional application No. 61/420,083, filed on Dec. 6, 2010.

(51) Int. Cl. G06Q 40/00

(52) U.S. Cl. 705/35

(57) ABSTRACT

Apparatuses, systems, and methods for estimating retirement costs for an individual are disclosed. The embodiments of this disclosure enable individuals to integrate the projected cost of healthcare into their retirement financial planning Embodiments of methods for estimating retirement costs for an individual may begin by receiving individual biographic data and individual healthcare data. Embodiments of the method may also include associating the individual healthcare data with one or more diagnosis related groups (or episode treatment groups). In some embodiments, the method may include estimating healthcare costs for each of the one or more diagnosis related groups based on historic healthcare records. In some embodiments, the method may further include calculating total healthcare costs in response to the estimated healthcare costs and the individual biographic data.

### BACKGROUND OF THE INVENTION

1. Field of the Invention

This invention relates to health and wealth planning and more particularly relates to apparatuses, systems, and methods for estimating an individual's retirement healthcare spending.

2. Description of the Related Art

A wealth focus has been placed on asset accumulation and planning for the retirement years. For example, an individual may consult a financial advisor the estimate the amount of wealth that needs to be accrued for retirement. Less focus has been placed on planning for medical costs throughout later life stages including, for example, retirement.

### SUMMARY OF THE INVENTION

Methods are disclosed. In some embodiments, a method for estimating retirement costs for an individual are disclosed. In some embodiments, the method includes receiving individual biographic data. In some embodiments, the method includes receiving individual healthcare data. In some embodiments, the method includes associating, with a processing device, the individual healthcare data with one or more diagnosis related groups. In some embodiments, the method includes estimating healthcare costs for each of the one or more diagnosis related groups based on historic healthcare records. In some embodiments, the method includes calculating, with the processing device, total healthcare costs in response to the estimated healthcare costs and the individual biographic data.

In some embodiments, the method may include receiving individual financial data. In some embodiments, the method may include estimating retirements costs in response to the individual biographic data, the individual financial data and, the total healthcare costs.

In some embodiments, the method may include providing one or more retirement planning recommendations.

In some embodiments, the one or more diagnosis related groups may include episode treatment groups.

In some embodiments, the individual health care data may include one or more medical claim records.

In some embodiments, calculating total healthcare costs further may include calibrating the total healthcare costs. In some embodiments, calculating total healthcare costs further may include calculating a healthcare cost band.

In some embodiments, individual biographic data may include age, gender, height, and weight. In some embodiments, individual financial data may include projected retirement savings; estimated retirement income; and projected retirement age.

Systems are also disclosed. In some embodiments, a system for estimating retirement costs for an individual is disclosed. In some embodiments, the system may include a data storage device configured to store individual biographic data and individual healthcare data. In some embodiments, the system may include a server in communication with data storage device. In some embodiments, the system may be suitably programmed to associate the individual healthcare data with one or more diagnosis related groups. In some embodiments, the server may further be programmed to estimate healthcare costs for each of the one or more diagnosis related groups based on historic healthcare records. In some embodiments, the server may further be programmed to calculate total healthcare costs in response to the estimated healthcare costs and the individual biographic data.

In some embodiments, the data storage device may be configured to store individual financial data and the server may be further programmed to estimate retirements costs in response to the individual biographic data, the individual financial data and, the total healthcare costs.

In some embodiments, the server may be further programmed to provide one or more retirement planning recommendations.

In some embodiments of the system, the one or more diagnosis related groups may include episode treatment groups.

In some embodiments of the system, the individual health care data may include one or more medical claim records.

In some embodiments of the system, calculating total healthcare costs further may include calibrating the total healthcare costs. In some embodiments of the system, calculating total healthcare costs further comprises calculating a healthcare cost band.

In some embodiments of the system, individual biographic data may include age, gender, height, and weight. In some embodiments of the system, individual financial data may include projected retirement savings, estimated retirement income, and projected retirement age.

Computer program products are also disclosed. A computer program product may include a computer readable medium having computer usable program code executable to perform operations for estimating retirement costs for an individual. The operations of the computer program product may include receiving individual biographic data, receiving individual healthcare data, associating the individual healthcare data with one or more diagnosis related groups, estimating healthcare costs for each of the one or more diagnosis related groups based on historic healthcare records, and calculating total healthcare costs in response to the estimated healthcare costs and the individual biographic data.

The operations of the computer program product may further include receiving individual financial data and estimating retirements costs in response to the individual biographic data, the individual financial data and, the total healthcare costs.

The computer program product may further be configured to perform one or more of the disclosed methods.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for estimating retirement costs for an individual;

FIG. 2 is a schematic block diagram illustrating one embodiment of a database system for estimating retirement costs for an individual;

FIG. 3 is a schematic block diagram illustrating one embodiment of a computer system that may be used in accordance with certain embodiments of the system for estimating retirement costs for an individual;

FIG. 4 is a schematic logical diagram illustrating one embodiment of abstraction layers of operation in a system for estimating retirement costs for an individual;

FIG. 5 is a schematic block diagram illustrating one embodiment of an apparatus for estimating retirement costs for an individual;

FIG. 6 is a schematic flow chart diagram illustrating an embodiment of a method for estimating retirement costs for an individual;

FIG. 7 is a screenshot diagram representing one embodiment for receiving individual biographic data;

FIG. 8 is a screenshot diagram representing one embodiment for receiving individual healthcare data;

FIG. 9 is a screenshot diagram representing on embodiment of an healthcare cost band used to estimate retirement costs for an individual;

FIG. 10 is a screenshot diagram of an embodiment of a calculation of the total healthcare costs of an individual; and

FIG. 11 is a screenshot diagram of an embodiment of providing retirement plan recommendations and their effect on total healthcare costs.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

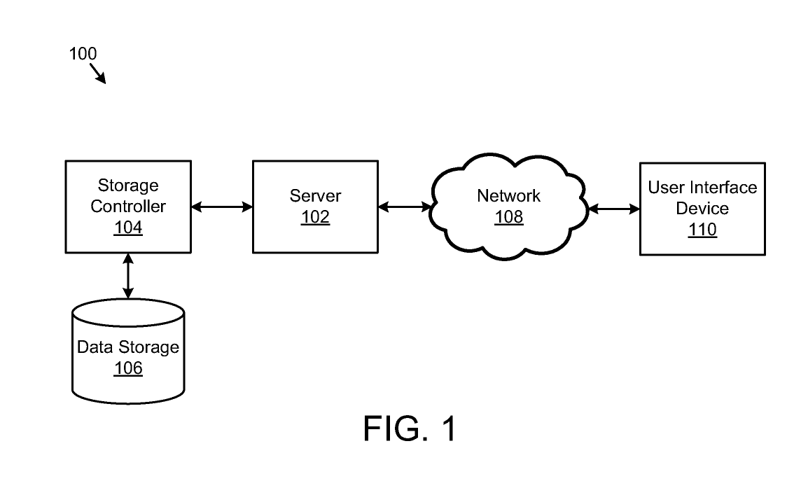

FIG. 1 illustrates one embodiment of a system 100 for estimating retirement costs for an individual. The system 100 may include a server 102, a data storage device 104, a network 108, and a user interface device 110. In a further embodiment, the system 100 may include a storage controller 106, or storage server configured to manage data communications between the data storage device 104, and the server 102 or other components in communication with the network 108. In an alternative embodiment, the storage controller 106 may be coupled to the network 108. In a general embodiment, the system 100 may estimate retirement costs for an individual. Specifically, the system 100 may determine the financial impact of an individual's current health status and lifestyle choices on retirement planning As such, the system 100 may integrate the calculated healthcare costs an individual into the individual's retirement planning

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, the user may enter biographic data (e.g., age, gender); individual healthcare data (e.g., healthcare ailments, life expectancy); and/or individual financial data (e.g., retirement savings, retirement goals).

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is configured to receive individual biographic and healthcare data; associate the individual healthcare data with one or more diagnosis related groups, estimate healthcare costs for each of the one or more diagnosis related groups, and calculate total healthcare costs. Additionally, the server may access data stored in the data storage device 104 via a Storage Area Network (SAN) connection, a LAN, a data bus, or the like.

The data storage device 104 may include a hard disk, including hard disks arranged in an Redundant Array of Independent Disks (RAID) array, a tape storage drive comprising a magnetic tape data storage device, an optical storage device, or the like. In one embodiment, the data storage device 104 may store health related data, such as insurance claims data, consumer data, or the like. The data may be arranged in a database and accessible through Structured Query Language (SQL) queries, or other data base query languages or operations.

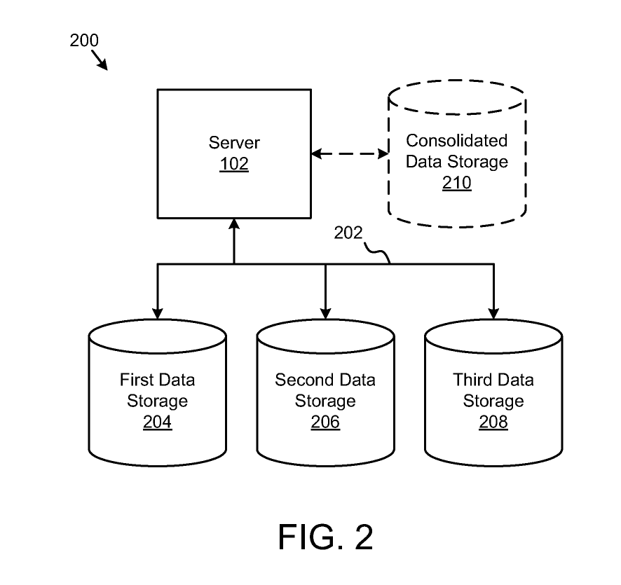

FIG. 2 illustrates one embodiment of a data management system 200 configured to store and manage data for estimating retirement costs for an individual. In one embodiment, the system 200 may include a server 102. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of individual biographic data, healthcare data, and/or financial data. The individual information in each database may be keyed to a common field or identifier, such as an individual's name, social security number, customer number, or the like. Alternatively, the storage devices 204-208 may be arranged in a RAID configuration for storing redundant copies of the database or databases through either synchronous or asynchronous redundancy updates.

In one embodiment, the server 102 may submit a query to selected data storage devices 204-206 to collect a consolidated set of data elements associated with an individual or group of individuals. The server 102 may store the consolidated data set in a consolidated data storage device 210. In such an embodiment, the server 102 may refer back to the consolidated data storage device 210 to obtain a set of data elements associated with a specified individual. Alternatively, the server 102 may query each of the data storage devices 204-208 independently or in a distributed query to obtain the set of data elements associated with a specified individual. In another alternative embodiment, multiple databases may be stored on a single consolidated data storage device 210.

In various embodiments, the server 102 may communicate with the data storage devices 204-210 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, the server 102 may communicate indirectly with the data storage devices 204-210; the server first communicating with a storage server or storage controller 106.

In one example of the system 200, the first data storage device 204 may store data associated with insurance claims made by one or more individuals. The insurance claims data may include data associated with medical services, procedures, and prescriptions utilized by the individual. In one particular embodiment, the first data storage device 204 may include insurance claims data for over 56 million customers of a health insurance company. The second data storage device 206 may store marketing data. For example, the marketing data may include information relating to the individual's income, race or ethnicity, credit ratings, etc. In one embodiment, the marketing database may include marketing information available from a commercial direct marketing data provider.

The server 102 may host a software application configured for estimating retirement costs for an individual. The software application may further include modules for interfacing with the data storage devices 204-210, interfacing a network 108, interfacing with a user, and the like. In a further embodiment, the server 102 may host an engine, application plug-in, or application programming interface (API). In another embodiment, the server 102 may host a web service or web accessible software application.

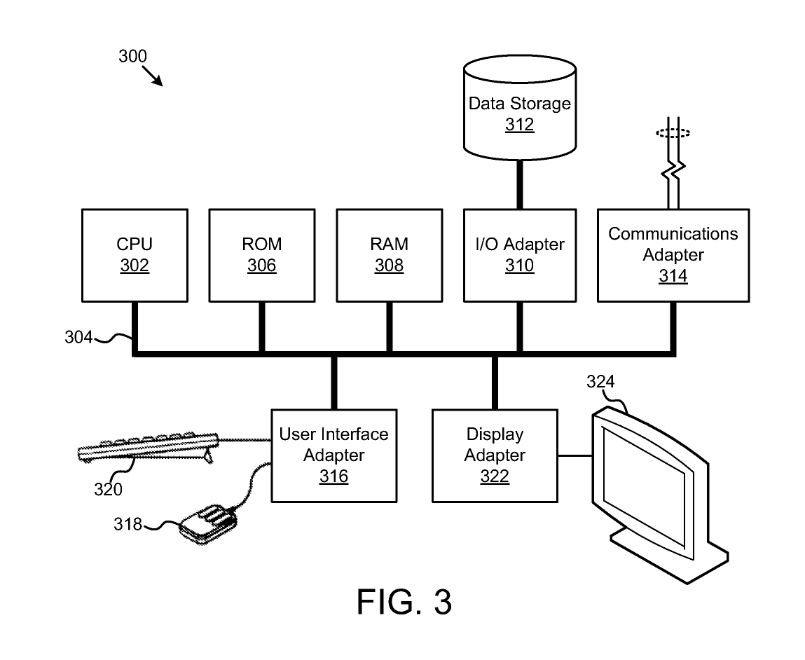

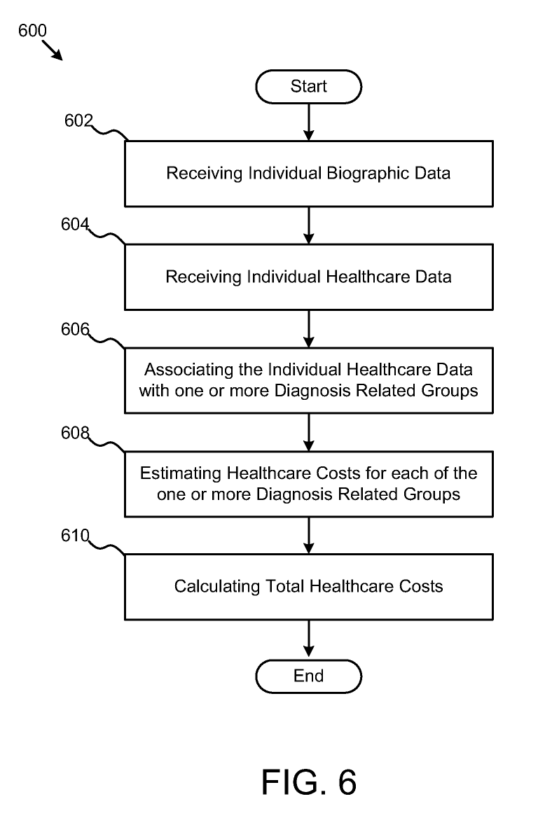

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIG. 6.

The computer system 300 also may include Random Access Memory (RAM) 308, which may be SRAM, DRAM, SDRAM, or the like. The computer system 300 may utilize RAM 308 to store the various data structures used by a software application configured to estimate retirement costs for an individual. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information for individual biographic, healthcare, and/or financial data. In a further embodiment, the display adapter 322 may display a graphical user interface associated with a software or web-based application for estimating retirement costs for an individual.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 106, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

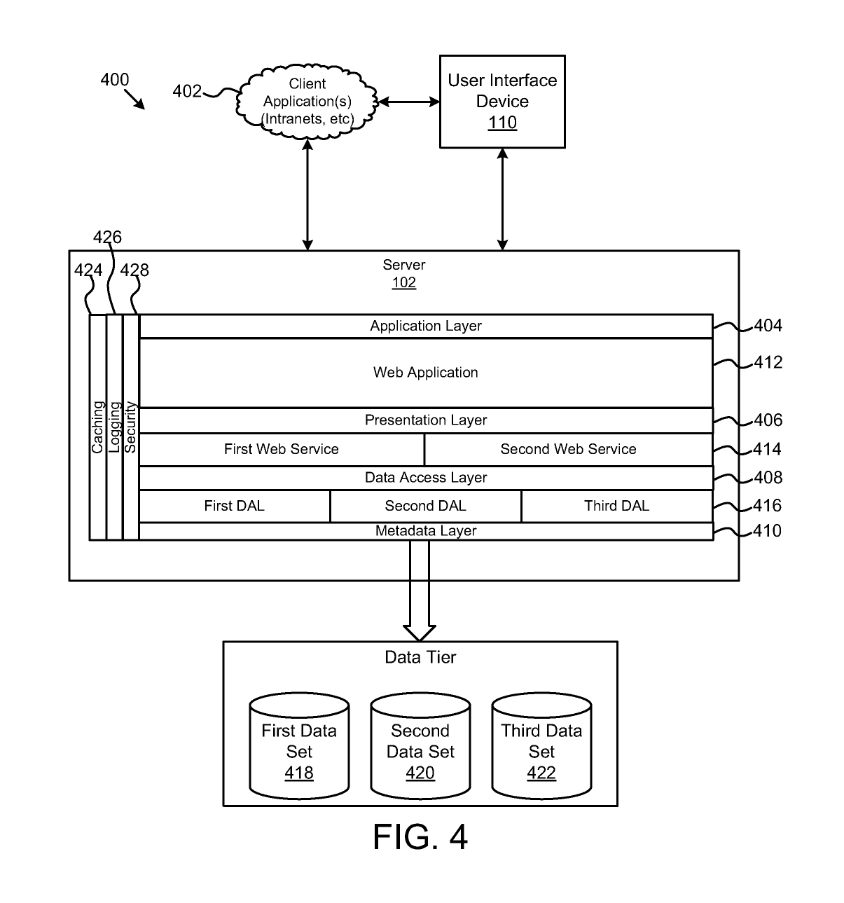

FIG. 4 illustrates one embodiment of a network-based system 400 for estimating retirement costs for an individual. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 422-422 that comprise a data layer or data tier. For example, a first data set 422, a second data set 420 and a third data set 422 may comprise a data tier that is stored on one or more data storage devices 204-208.

One or more web applications 412 may operate in the application layer 404. For example, a user may interact with the web application 412 though one or more I/O interfaces 318, 320 configured to interface with the web application 412 through an I/O adapter 310 that operates on the application layer. In one particular embodiment, a web application 412 may be provided for estimating retirement costs for an individual that includes software modules configured to perform the steps of receiving individual biographic and healthcare data; associating the individual healthcare data with one or more related diagnosis groups, estimating healthcare costs for each of the one or more diagnosis related groups, and calculating total healthcare costs.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on a first server 102 and access one or more web services 414 hosted on a second server (not shown) during operation.

In one embodiment, a web application 412 or a web service 414 may access one or more of the data sets 418-422 through the data access layer 408. In certain embodiments, the data access layer 408 may be divided into one or more independent data access layers 416 for accessing individual data sets 418-422 in the data tier. These individual data access layers 416 may be referred to as data sockets or adapters. The data access layers 416 may utilize metadata from the metadata layer 410 to provide the web application 412 or the web service 414 with specific access to the data set 412.

For example, the data access layer 416 may include operations for performing a query of the data sets 418-422 to retrieve specific information for the web application 412 or the web service 414. In a more specific example, the data access layer 416 may include a query for one or more medical claims records associated with a specific diagnosis related group.

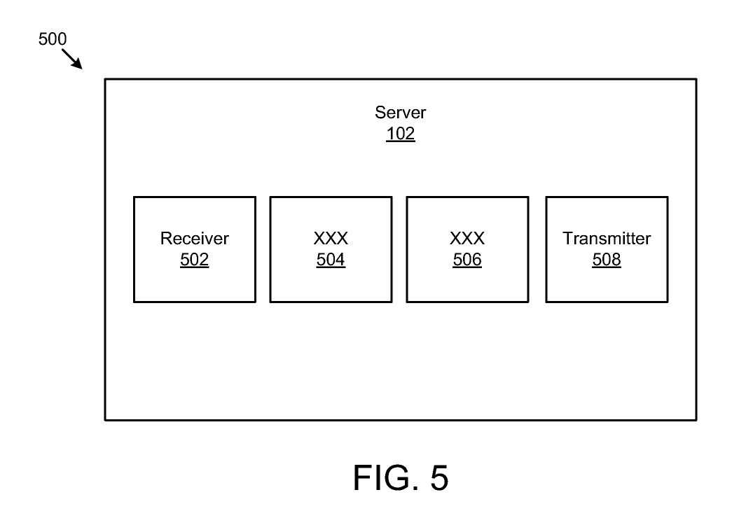

FIG. 5 illustrates a further embodiment of a system 500 for estimating retirement costs for an individual. In one embodiment, the system 500 may include a service provider site 502 and a client site 504. The service provider site 502 and the client site 504 may be separated by a geographic separation 506.

In one embodiment, the system 500 may include one or more servers 102 configured to host a software application 412 for estimating retirement costs for an individual, or one or more web services 414 for performing certain functions associated with estimating retirement costs for an individual. The system may further comprise a user interface server 508 configured to host an application or web page configured to allow a user to interact with the web application 412 or web services 414 for estimating retirement costs for an individual. In such an embodiment, a service provider may provide hardware 102 and services 414 or applications 412 for use by a client without directly interacting with the client's customers.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

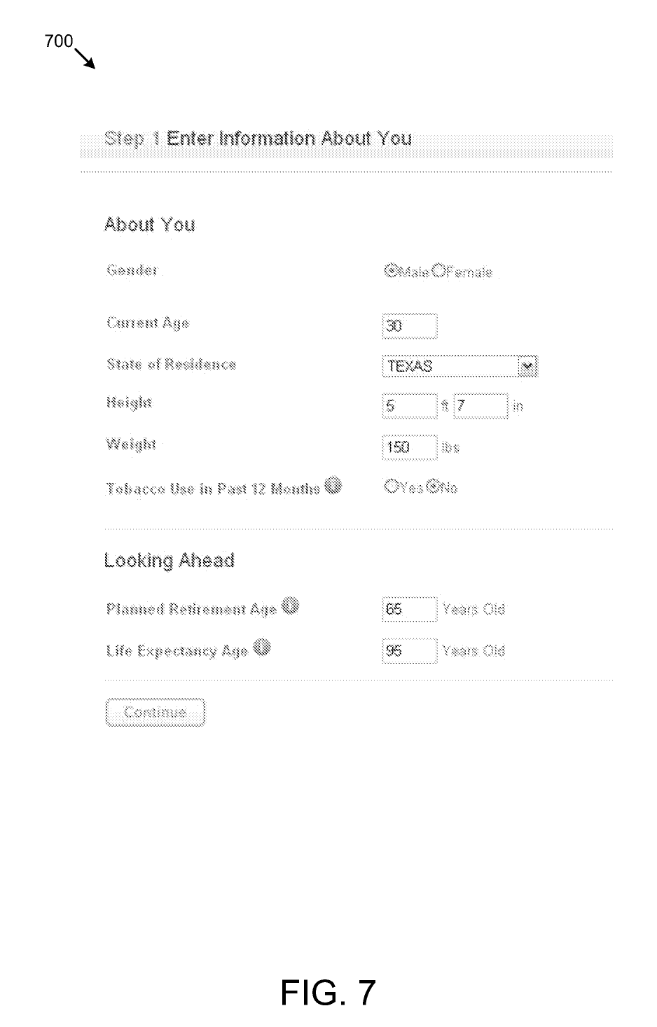

FIG. 6 illustrates one embodiment of a method 600 for estimating retirement costs for an individual. In one embodiment, the method 600 starts by receiving 602 individual biographic data. Individual biographic data may include basic indentifying information for an individual: such as, for example, name and social security number. Additionally, in some embodiments, individual biographic data may further include an individual's age, place of residence, gender, height, and/or weight. FIG. 7 represents one embodiment of a user interface configured to receive individual biographic data. As shown in screenshot 700, in this embodiment, gender, current age, state of residence, height, weight, and tobacco use in the past 12 months may be entered in the “About You” section.

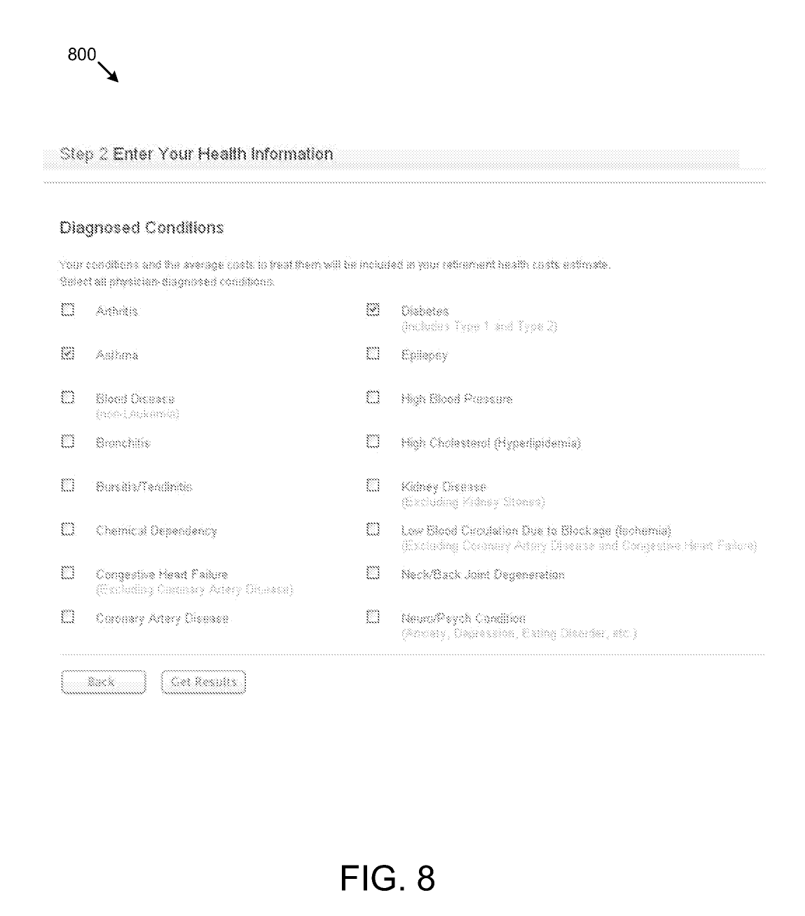

Returning to FIG. 6, the method 600 may also include receiving 604 individual healthcare data. Naturally, the steps of receiving 602 individual biographic data and receiving 604 individual healthcare data can be performed in any order. In some embodiments, individual healthcare data may be received directly from a user input. For example, FIG. 8 represents one embodiment of a user interface for receiving individual biographic data. As shown in FIG. 8, an individual may be able select (e.g., by using a check box) which health conditions will be included for the individual's retirement costs estimate. Thus, the individual in screenshot 800 has selected asthma and diabetes. As expected, individuals with one or more health conditions will have higher retirement health costs.

Individual healthcare data may also include an estimated and/or calculated life expectancy for an individual. As shown in FIG. 7, life expectancy age is an input that may be received by user interface 700. In other embodiments, however, an individual's life expectancy may be calculated based on their medical history or other like factors.

In some embodiments, individual healthcare data may be culled—automatically or manually—from a healthcare claims database. As discussed with respect to FIGS. 2 and 4, a data storage device may store insurance claims data and/or marketing for the millions of customers of a health insurance company. Analysis and data mining of this claims data can identify one or more health conditions applicable to a given individual. For example, an individual's prior history of medical claims may enable that determination of which health conditions that individual is diagnosed with or has a likelihood of being diagnosed with in the future.

Receiving individual healthcare data from medical claims data, rather than user inputs, may be elicit a more comprehensive view of an individual's health. For example, in some embodiments, receiving individual healthcare data may also include receiving healthcare data about one or more family members of an individual. As such, if an individual has a family history of diabetes and/or heart disease, a likelihood for developing these conditions may be incorporated into the estimate of retirement costs.

In some embodiments, permission may be received from an individual to access his or her medical claims records. By incorporating such a permission requirements may be used to protect an individual's privacy.

Moving on with FIG. 6, the method 600 may also include associating 606 the individual healthcare data with one or more diagnosis related groups. As discussed previously, the received individual healthcare data may identify one or more health conditions associated with an individual. These health conditions may further be associated with a particular diagnosis related group (DRG). DRGs provide a system of classifying patients on the into one or more groups based on their diagnosis, procedures, ages, sex, discharge status, and the presence of complications or co-morbidities. Examples of DRGs include “psychoses,” “hip/knee replacement,” “pneumonia,” and the like. By analyzing individual healthcare data, an individual may be associated with one or more DRGs. For example, in an adult individual selects that he or she has asthma, that individual may be associated with “bronchitis and asthma age greater than 17 without complications and comorbidities.” Similarly, an analysis of a patient's medical records—using data mining techniques—may similarly associate the individual with the same DRG.

In some embodiments, these DRGs may be associated with a timestamp and/or time period. As expected a childhood illness or condition may have less effect on retirement healthcare costs than a disease or illness suffered later in life. A timestamp and/or time period information may also provide further details regarding the duration of a given condition.

In some embodiments, the DRGs may be episode treatment groups (ETGs). An ETG is a patient classification unit, which defines groups that are clinically homogenous (e.g., a similar cause of illness and treatment) and statistically stable. Definitions of various ETGs, methods data mining claim records and associating those claim records with ETGS, and more information regarding ETGs may be found in U.S. Pat. No. 6,370,511 and U.S. Pat. No. 5,835,897 both titled, “Computer-Implemented Method for Profiling Medical Claims,” and in U.S. Pat. No. 7,774,216 titled, “Computer Implemented Method for Grouping Medical Claims Based Upon Changes in Patient Condition.” These three U.S. patents are incorporated herein by reference. As discussed in these references, examples of ETGs may include such groups as “lupus with complication,” “lupus without complication,” “open wound of the skin, w/o surgery,” and “hemorrhage during pregnancy, with cesarean section.”

Continuing with FIG. 6, the method 600 may proceed by estimating the healthcare costs associated for each of the one or more diagnosis related groups. For example, a particular individual's healthcare data may be associated with a diagnosis related group: bone marrow transplant. Estimating the healthcare costs associated with that diagnosis related group may include analyzing historic healthcare records of past patients that are also associated with that DRG. In some embodiments, the historic healthcare records may include past patients with similar individual biographic and/or healthcare data to the particular individual whose total healthcare costs are being calculated. Moreover, if the particular individual had a bone marrow transplant at the age of 45, and that individual is currently a male of age 50, historic healthcare records may be data mined to find medical records of similarly situated individuals.

In some embodiments, the yearly cost associated with a particular DRG may be calculated. For example, by analyzing medical claims records and thereby determining costs for multiple similarly situated individuals associated with a particular DRG, an estimate of the cost associated with that DRG may be developed. Furthermore, this estimated cost may further be described over time to determine an annual cost associated with a DRG. For a 50 year old male associated with the bone marrow transplant DRG at age 45, the healthcare costs associated with that particular DRG may be determined for a particular year in the future—for example five years later at age 55. Moreover, the analysis of similarly situated individuals belonged to that DRG may reveal that 10 years after their bone marrow transplant procedure, they may continue to have certain healthcare costs related to that procedure or diagnosis.

In some embodiments, a similar estimation may be performed for each year between an individual's current age through the individual's projected life expectancy. As such, a curve for the projected healthcare costs associated with a particular DRG may be developed. If an individual's healthcare data associates that individual with more than one DRG, similar estimations and/or curves may be developed to project the estimated healthcare costs associated with each DRG over time.

The method 600 may continue by calculating 610 the total healthcare costs in response to the estimated healthcare costs and the individual biographic data. In some embodiments, the total healthcare costs may further be calculated in response to individual healthcare data as well. In some embodiments, the estimated healthcare costs associated with each particular DRG can be aggregated together to determine the total healthcare costs of an individual. For example, it may be estimated that at age 55, a 45 year old individual has projected healthcare costs associated with multiple DRGs. These healthcare costs may be summed together—or otherwise aggregated—to determine the total healthcare costs. In embodiments where a yearly projection of the costs associated with each DRG has been calculated (e.g., by forming a curve), these projections may be summed or otherwise aggregated together.

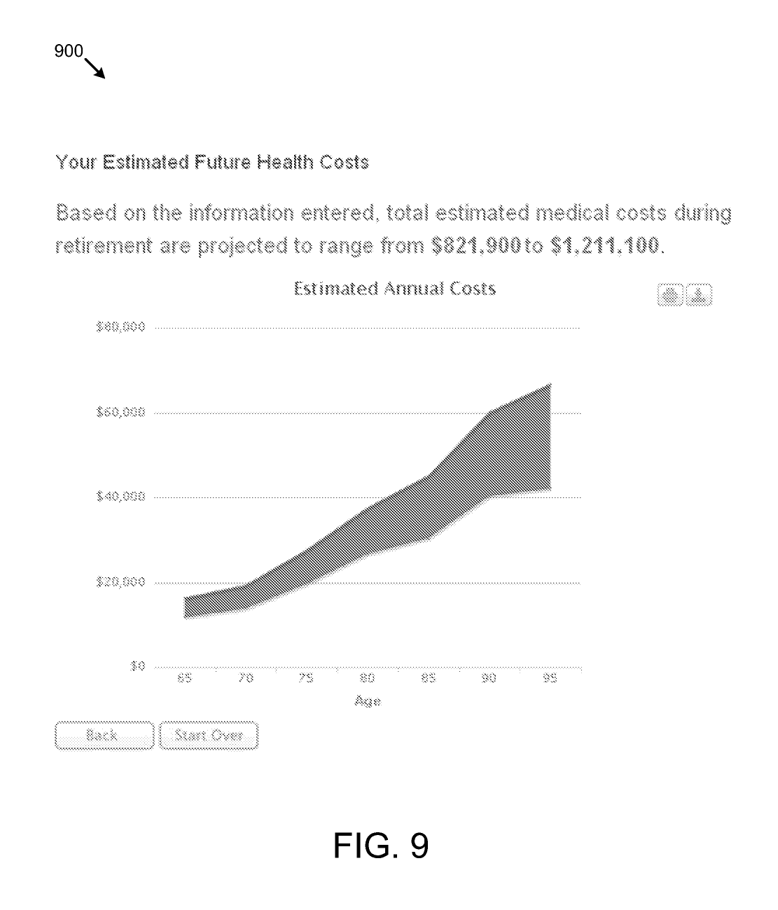

FIG. 9 illustrates one embodiment of the calculated total healthcare costs of an individual during retirement. In this particular embodiment, the individual is retiring at age 65 and has an expected life expectancy of 95 years. As shown in this embodiment, calculating 610 the total healthcare costs may comprise calculating a total healthcare cost band. As expected, it may be difficult to estimate the expected healthcare costs for an individual decades into the future. As such, a total healthcare cost band may provide an upper estimate and lower estimate—annually. Also as shown in FIG. 9, calculating 610 the total healthcare costs may comprise calculating a present value (PV) of these healthcare costs. For example, the graph in FIG. 9 estimates the annual healthcare costs for each year during retirement. In addition, the present value of the total amount of the annual healthcare costs are also calculated. For this embodiment, the present value is calculated to be in a range of $821,900 to $1,211,100.

In some embodiments, calculating 610 the total healthcare costs for an individual may further include additional calibration. The total healthcare costs number may be calibrated to account for various factors including: geography and/or inflation. For example, healthcare costs in certain regions may be more or less expensive than healthcare costs in other regions. As such, an upwards adjustment may be made to the total healthcare costs in more expensive regions. Similarly, an upwards adjustment may be made to the total healthcare costs in response to expected inflation.

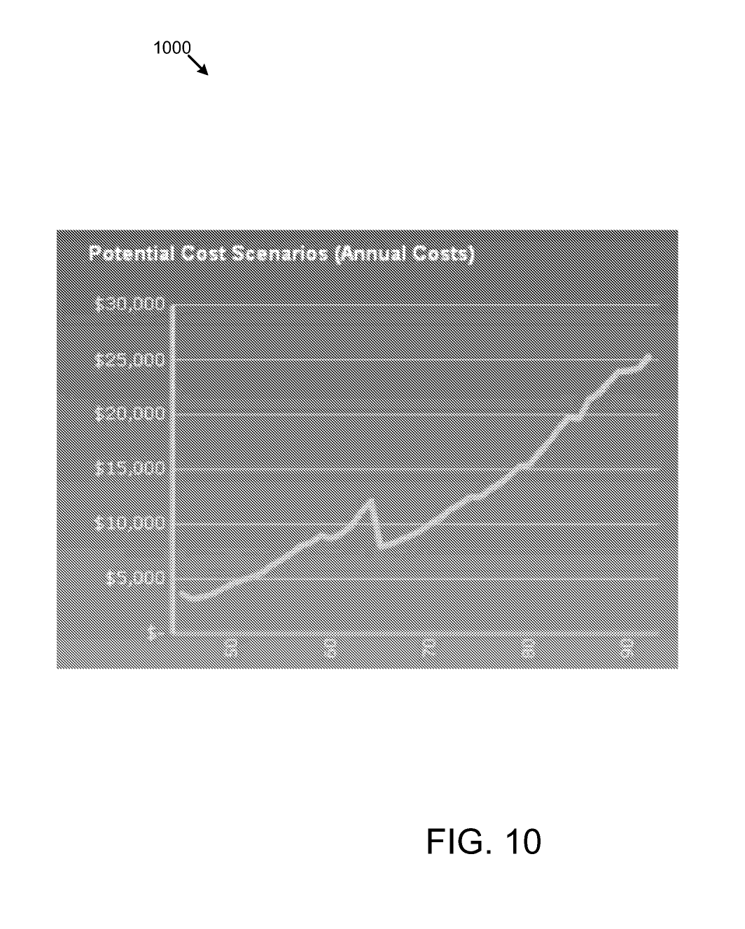

FIG. 10 illustrates a second example of calculating the total healthcare costs of an individual. As shown here, in this embodiment, a total healthcare cost band is not calculated, but instead the estimated total health care cost (e.g., average of the upper and lower limits of the band) is depicted as a line graph.

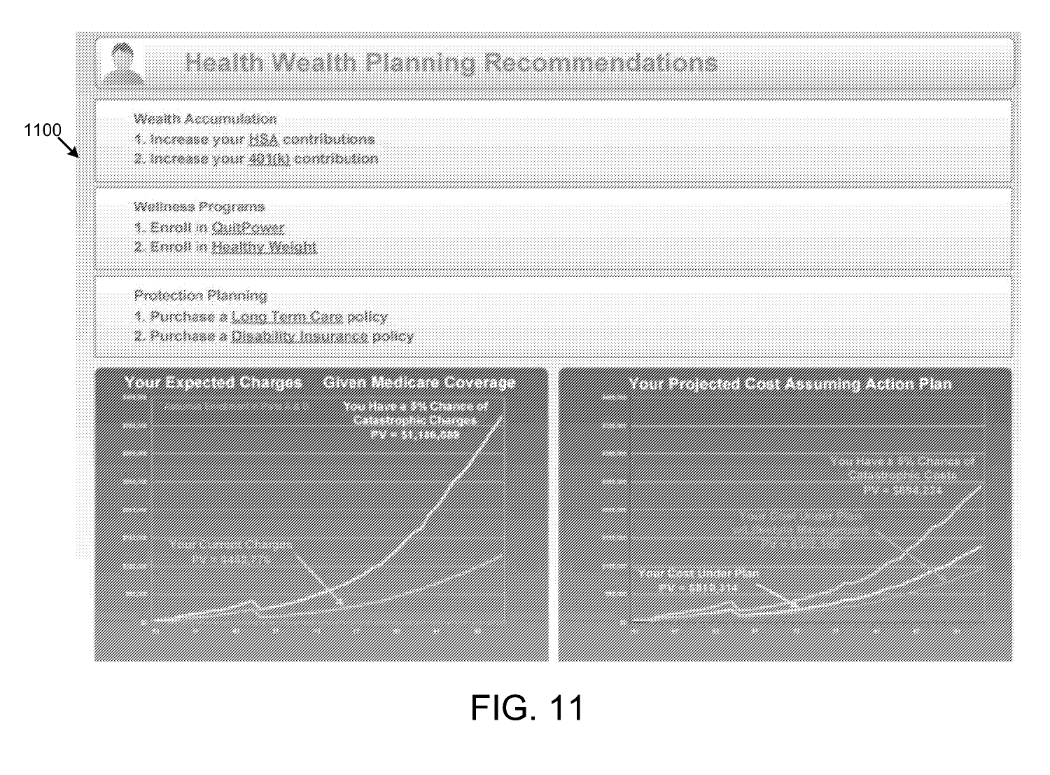

The graphs in FIG. 11 depict additional embodiments of calculations of the total healthcare costs for an individual. The graph on the left depicts the total healthcare costs of a particular individual and projects the present value of these costs at $452,776. Additionally, the graphs depict the total healthcare costs of a particular individual based on the 5% chance of catastrophic charges (e.g., a worst case scenario) of $1,186,889. As shown in the graph of the left, the total healthcare costs determined here further integrates enrollment in Medicare Parts A & B. In some embodiments, calculating total health care costs includes determining and accounting for health insurance coverage for an individual.

In some embodiments, the method 600 may further include providing one or more retirement planning recommendations. As shown in FIG. 11, these retirement planning recommendations may include financial advice (e.g., increasing Health Savings Account (HSA) contributions and/or increasing retirement plan contributions), wellness advice (e.g., enrolling in one or more wellness programs), and/or insurance advice (e.g., purchasing a long term care policy or disability insurance policy). As shown in the right graph of FIG. 11, in some embodiments, the total healthcare cost calculation may be adjusted to show the effect of participation in wellness programs and/or following other retirement planning recommendations.

The method 600 may further include receiving individual financial data. For example, such individual financial data may include the expected retirement age of an individual, the anticipated retirement savings of an individual, the anticipated additional income that may be received during retirement, and the anticipated lifestyle expenses of an individual.

In some embodiments, the method 600 may further include estimating the retirement costs of an individual in response to the individual biographic data, the individual financial data, and the total healthcare costs. Financial calculators may be available to estimate the total amount of money that an individual needs to save for retirement, but these calculators do not accurately take into account the cost of healthcare. The calculated total healthcare costs may be combined with an individual's financial and biographic data to determine an actual total amount of money that an individual should save for retirement.

For example, before incorporating the total healthcare costs, it may be determined that an individual needs to save $1.5 million dollars for retirement. As such, a retirement plan with a financial advisor may be developed for that individual so that he or she can save $1.5 million for retirement. With the disclosed methods, an individual may be able to determine that he or she needs to save an additional $500,000 for retirement based on his or her projected total healthcare costs. As such, the individual can now revise his or her retirement plan to save more money for retirement and ensure that he or she has $2,000,000 or more saved. The embodiments of this disclosure allow for the combined planning of both health and wealth considerations in retirement.

In some embodiments, a user may be given the option to save the some or all of the individual biographic data, the individual financial data, and/or the estimated retirement costs (e.g., as shown in FIGS. 9-11) for future reference and/or to use as financial planning aids. In other embodiments, less than all of the individual biographic data, the individual financial data, and/or the estimated retirement costs may be saved. In still other embodiments, individual biographic data, the individual financial data, and/or the estimated retirement costs are saved but are not associated with the individual (i.e., are anonymized).

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method for estimating retirement costs for an individual comprising:
receiving individual biographic data;
receiving individual healthcare data;
associating, with a processing device, the individual healthcare data with one or more diagnosis related groups;
estimating healthcare costs for each of the one or more diagnosis related groups based on historic healthcare records; and
calculating, with the processing device, total healthcare costs in response to the estimated healthcare costs and the individual biographic data.

2. The method of claim 1, where the method further comprises:
receiving individual financial data; and
estimating retirements costs in response to the individual biographic data, the individual financial data and, the total healthcare costs.

3. The method of claim 2, further comprising providing one or more retirement planning recommendations.

4. The method of claim 1, the one or more diagnosis related groups comprising episode treatment groups.

5. The method of claim 1, the individual health care data comprising one or more medical claim records.

6. The method of claim 1, where calculating total healthcare costs further comprises calibrating the total healthcare costs.

7. The method of claim 1, where calculating total healthcare costs further comprises calculating a healthcare cost band.

8. The method of claim 1, where individual biographic data comprises:
age;
gender;
height; and
weight.

9. The method of claim 1, where individual financial data comprises:
projected retirement savings;
estimated retirement income; and
projected retirement age.

10. A system for estimating retirement costs for an individual comprising:
a data storage device configured to store individual biographic data and individual healthcare data;
a server in communication with data storage device suitably programmed to:
associate the individual healthcare data with one or more diagnosis related groups;
estimate healthcare costs for each of the one or more diagnosis related groups based on historic healthcare records; and
calculate total healthcare costs in response to the estimated healthcare costs and the individual biographic data.

11. The system of claim 10, the data storage device configured to store individual financial data and the server further programmed to estimate retirements costs in response to the individual biographic data, the individual financial data and, the total healthcare costs.

12. The system of claim 11, the server further programmed to provide one or more retirement planning recommendations.

13. The system of claim 10, the one or more diagnosis related groups comprising episode treatment groups.

14. The system of claim 10, the individual health care data comprising one or more medical claim records.

15. The system of claim 10, where calculating total healthcare costs further comprises calibrating the total healthcare costs.

16. The system of claim 10, where calculating total healthcare costs further comprises calculating a healthcare cost band.

17. The system of claim 10, where individual biographic data comprises:
age;
gender;
height; and
weight.

18. The system of claim 10, where individual financial data comprises:
projected retirement savings;
estimated retirement income; and
projected retirement age.

19. A computer program product comprising a computer readable medium having computer usable program code executable to perform operations for estimating retirement costs for an individual, the operations of the computer program product comprising:
receiving individual biographic data;
receiving individual healthcare data;
associating the individual healthcare data with one or more diagnosis related groups;
estimating healthcare costs for each of the one or more diagnosis related groups based on historic healthcare records; and
calculating total healthcare costs in response to the estimated healthcare costs and the individual biographic data.

20. The computer program product of claim 19, the operations further comprising:
receiving individual financial data; and
estimating retirements costs in response to the individual biographic data, the individual financial data and, the total healthcare costs.
